(19) United States
(12) Patent Application Publication
(10) Pub. No.: US 2025/0127217 A1
(43) Pub. Date: Apr. 24, 2025

(54) A CONSUMABLE FOR USE WITH AN AEROSOL PROVISION DEVICE

(71) Applicant: NICOVENTURES TRADING LIMITED, London (GB)

(72) Inventors: Paul GIBSON, London (GB); Barnaby OAKLEY, London (GB)

(21) Appl. No.: 18/681,128

(22) PCT Filed: Aug. 4, 2022
(86) PCT No.: PCT/EP2022/071999

§ 371 Date: Feb. 5, 2024

(30) Foreign Application Priority Data
Aug. 4, 2021 (GB) 2111280.0
Dec. 20, 2021 (GB) 2118574.9

(51) Int. Cl. A24F 40/20; A24F 40/42; A24F 40/465; A24F 40/70; H05B 6/10

(52) U.S. Cl. CPC A24F 40/20; A24F 40/42; A24F 40/465; A24F 40/70; H05B 6/105

(57) ABSTRACT

A method of manufacturing a consumable for use with a non-combustible aerosol provision system is provided. The consumable includes a support and aerosol generating material. The method includes: providing a support; causing the formation of at least one enhanced area on the support; and applying the aerosol generating material to the support in at least one position that corresponds to at least part of at least one enhanced area.

### RELATED APPLICATIONS

The present application is a National Phase entry of PCT Application PCT/EP2022/071999 filed Aug. 4, 2022, which claims priority to GB Application No. 2111280.0 filed Aug. 4, 2021 and GB Application No. 2118574.9 filed Dec. 20, 2021, all of which are hereby incorporated by reference in their entirety.

### TECHNICAL FIELD

This disclosure relates to the field of non-combustible aerosol-provision systems, in particular to consumables for use with an aerosol provision device, a method for manufacturing consumables for use with an aerosol provision device, and an aerosol provision system including a consumable and an aerosol provision device.

### BACKGROUND

Smoking articles such as cigarettes, cigars and the like burn tobacco during use to create tobacco smoke. Alternatives to these types of articles release an inhalable aerosol or vapor by releasing compounds from a substrate material by heating without burning. These may be referred to as non-combustible smoking articles, aerosol generating assemblies, or aerosol provision devices.

One example of such a product is a heating device which release compounds by heating, but not burning, an aerosolizable material which may be referred to as a solid aerosol-generating material. This solid aerosol-generating material may, in some cases, contain a tobacco material. The heating volatilizes at least one component of the material, typically forming an inhalable aerosol. These products may be referred to as heat-not-burn devices, tobacco heating devices or tobacco heating products. Various different arrangements for volatilizing at least one component of the solid aerosol-generating material are known.

As another example, there are hybrid devices. These hybrid devices contain a liquid source (which may or may not contain nicotine) which is vaporized by heating to produce an inhalable vapor or aerosol. The device additionally contains a solid aerosol-generating material (which may or may not contain a tobacco material) and components of this material are entrained in the inhalable vapor or aerosol to produce the inhaled medium.

### SUMMARY

According to a first aspect of the present disclosure there is provided a method of manufacturing a consumable for use with a non-combustible aerosol provision system, in which the consumable comprises a support and aerosol generating material, in which the method comprises
providing a support,
causing the formation of at least one enhanced area on the support,
applying the aerosol generating material to the support in at least one position that corresponds to at least part of at least one enhanced area.

According to a second aspect of the present disclosure there is provided a consumable for use with a non-combustible aerosol provision system, in which the consumable comprises a support, at least one enhanced area on the support, and aerosol generating material, and the aerosol generating material is supported on the support in at least one position that corresponds to at least part of at least one enhanced area.

According to a third aspect of the present disclosure there is provided an aerosol provision device for use with a consumable according to the second aspect of the present disclosure, in which the device comprises an aerosol generator configured to heat at least a portion of the aerosol generating material supported on the consumable.

According to a fourth aspect of the present disclosure there is provided an aerosol provision system comprising an aerosol provision device and a consumable according to the second aspect of the present disclosure.

According to a fifth aspect of the present disclosure there is provided a method of generating aerosol from a consumable according to the second aspect of the present disclosure using an aerosol-generating device with at least one aerosol generator disposed to heat, but not burn, the consumable in use; wherein at least one aerosol generator is a resistive heater element or a magnetic field generator and a susceptor.

Further features and advantages of the present disclosure will become apparent from the following description of embodiments of the disclosure given by way of example and with reference to the accompanying drawings.

### DRAWINGS

FIG. 1 shows a schematic view of an embodiment of an aerosol provision device and an embodiment of a consumable manufactured according to a first embodiment of a method of the present disclosure;

FIG. 2 shows a first embodiment of a support used in the manufacture of the consumable of FIG. 1;

FIG. 3 shows the support of FIG. 2 once a first embodiment of enhanced areas have been formed;

FIG. 4 shows the support of FIG. 3 after aerosol generating material has been applied to the support;

FIGS. 5 and 6 show the support of FIG. 2 during the formation of a second embodiment of the enhanced areas;

FIG. 7 shows the support of FIGS. 5 and 6 after aerosol generating material has been applied to the support;

FIG. 8 shows a second embodiment of the support of FIGS. 5 and 6 after aerosol generating material has been applied to the support;

FIGS. 9 and 10 show the support of FIG. 2 during the formation of a third embodiment of the enhanced areas;

FIG. 11 shows portions of susceptor ready for use in the formation of a third embodiment of the enhanced areas;

FIG. 12 shows the support of FIGS. 9 and 10 after aerosol generating material has been applied to the support;

FIGS. 13 and 14 show a second embodiment of a support used in the manufacture of the consumable of FIG. 1;

FIGS. 15 to 18 show the support of FIGS. 13 and 14 during the formation of a fourth embodiment of the enhanced areas; and

FIGS. 19 and 20 shows the support of FIGS. 13 to 18 after aerosol generating material has been applied to the support.

### DETAILED DESCRIPTION

The consumable of the present description may be alternatively referred to as an article.

In some embodiments, the consumable comprises aerosol-generating material. The consumable may comprise an aerosol-generating material storage area, an aerosol-generating material transfer component, an aerosol generator, an aerosol generation area, a housing, a wrapper, an aerosol-modifying agent, one or more active constituents, one or more flavors, one or more aerosol-former materials, and/or one or more other functional materials.

The apparatus for heating the aerosol-generating material with which the consumable is to be used is a part of a non-combustible aerosol provision system. Non-combustible aerosol provision systems release compounds from an aerosol-generating material without combusting the aerosol-generating material, such as electronic cigarettes, tobacco heating products, and hybrid systems to generate aerosol using a combination of aerosol-generating materials.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

According to a first aspect of the present disclosure there is provided a method of manufacturing a consumable for use with a non-combustible aerosol provision system, in which the consumable comprises a support and aerosol generating material, in which the method comprises
providing a support,
causing the formation of at least one enhanced area on the support,
applying the aerosol generating material to the support in at least one position that corresponds to at least part of at least one enhanced area.

In an embodiment of the above embodiment, the aerosol generating material is applied to a surface of the support as a slurry of aerosol generating material.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise one or more active substances and/or flavors, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be formed by combining a binder, such as a gelling agent, with a solvent, such as water, an aerosol-former and one or more other components, such as one or more substances to be delivered, to form a slurry and then heating the slurry to volatilize at least some of the solvent to form the aerosol-generating film.

The slurry may be heated to remove at least about 60 wt %, 70 wt %, 80 wt %, 85 wt % or 90 wt % of the solvent.

The aerosol-generating material may comprise or be an “amorphous solid”. In some embodiments, the aerosol-generating material comprises an aerosol-generating film that is an amorphous solid. The amorphous solid may be a “monolithic solid”. The amorphous solid may be substantially non-fibrous. In some embodiments, the amorphous solid may be a dried gel. The amorphous solid is a solid material that may retain some fluid, such as liquid, within it. In some embodiments, the amorphous solid may, for example, comprise from about 50 wt %, 60 wt % or 70 wt % of amorphous solid, to about 90 wt %, 95 wt % or 100 wt % of amorphous solid.

The amorphous solid may be substantially free from botanical material. The amorphous solid may be substantially tobacco free.

In an embodiment of any of the above embodiments, the method includes a further step of allowing or causing the slurry of aerosol generating material to set. The slurry of aerosol generating material may be caused to set using known techniques for causing aerosol generating material slurry to set.

In an embodiment of any of the above embodiments the slurry of aerosol generating material sets as aerosol generating material in the form of an aerosol generating film.

The support may be of a material suitable to form a substrate. The support may, for example, be or comprise paper, card, paperboard, cardboard, reconstituted material, a plastics material, a ceramic material, a composite material, glass, a metal, or a metal alloy.

In an embodiment of any of the above embodiments the support comprises a plastics material which can withstand the temperatures typically encountered in a non-combustible aerosol provision device. In some embodiments the support comprises polyether ether ketone (PEEK). Such embodiments have the advantage that the support may be reused, and that the consumable is less affected by any condensation in the non-combustible aerosol provision device than consumables that comprise a support which includes use of a sorbent material for structural purposes.

An enhanced area on a surface of the support is an area of the support that has a characteristic that is more desirable than or different to (i) the equivalent characteristic of non-enhanced areas on the surface of the support, and/or (ii) the equivalent characteristic of an area on the surface of the support before that area is enhanced.

In an embodiment of any of the above embodiments an enhanced area is an area in which the enhancement is that the rigidity of the support is greater than the rigidity of the support in an area of the support that is not enhanced, and the formation of at least one enhanced area comprises increasing the rigidity of the support in at least part of at least one enhanced area. In some embodiments the rigidity of the support is increased in substantially all of at least one enhanced area.

An advantage of increasing the rigidity of at least part of at least one enhanced areas is that such areas are less likely to flex or distort over the course of time than the less rigid non-enhanced part of the support. As a result, it is less likely that aerosol generating material applied to such an enhanced area will delaminate (separate) from the support than if the aerosol generating material were applied to the less rigid non-enhanced part of the support. This increases the usable life of a consumable manufactured according to the present disclosure.

In an embodiment of any of the above embodiments an enhanced area is an area in which the enhancement is that at least part of the surface of the area is contoured, and the formation of at least one enhanced area comprises embossing or debossing the support in at least part of the at least one enhanced area. In some embodiments the embossing or debossing of the support covers substantially all of at least one enhanced area.

An advantage of embossing or debossing the support is that the adhesion of an aerosol generating material to the support is better, that is stronger, for a contoured surface, such as a surface produced by embossing or debossing, than for a smooth non-contoured surface. A further advantage is an increase in the rigidity of the enhanced area. This gives rise to the advantages described above.

A further possible advantage of embossing or debossing the support in at least part of at least one enhanced area is that it may assist in the positioning of aerosol generating material applied to the embossed or debossed area relative to one or means for heating the aerosol generating material when the consumable is to be used. The embossing/debossing may, for example, result in the aerosol generating material being closer to a heating means than other parts of the support. This would have the advantage that the heating of the aerosol generating material is more efficient than if the aerosol generating material were further from the heater. Further, surrounding the aerosol generating material is a space greater than that between the aerosol generating material and the heater allows the aerosol generated to move away from the aerosol generating material and toward a desired destination for the aerosol.

In an embodiment of any of the above embodiments an enhanced area is an area in which the enhancement is that the thermal transmissivity of the support is greater than the thermal transmissivity of the support in an area of the support that is not enhanced, and the formation of at least one enhanced area comprises increasing the thermal transmissivity of at least part of at least one enhanced area. In some embodiments the thermal transmissivity of the support is increased in substantially all of at least one enhanced area.

An advantage of increasing the thermal transmissivity in an enhanced area is that it will increase the efficiency of heating aerosol generating material applied to the enhanced area when it is desired to generate an aerosol from the aerosol generating material.

In an embodiment of any of the above embodiments the thermal transmissivity is increased for at least part of the surface of the support within at least part of at least one enhanced area.

In an embodiment of any of the above embodiments an enhanced area is an area in which the enhancement is that the thickness of the support is greater than the thickness of the support in an area of the support that is not enhanced, and the formation of at least one enhanced area comprises increasing the thickness of the support in at least part of at least one enhanced area. In some embodiments the thickness of the support is increased in substantially all of at least one enhanced area.

An advantage of thickening the support in at least part of at least one enhanced area is that it may assist in positioning of aerosol generating material applied to the thickened area relative to one or more means for heating the aerosol generating material when the consumable is to be used. The thickening may, for example, result in the aerosol generating material being closer to a heating means than other parts of the support. This has the advantage that the heating of the aerosol generating material is more efficient than if the aerosol generating material were further from the heater. Further, surrounding the aerosol generating material is a space greater than that between the aerosol generating material and the heater allows the aerosol generated to move away from the aerosol generating material and toward a desired destination for the aerosol.

As further advantage of the thickening of the support is the increase of the rigidity of the support for the reasons discussed above.

In an embodiment of any of the above embodiments an enhanced area is an area in which the enhancement is that the area comprises a susceptor, and the formation of at least one enhanced area comprises the application of a susceptor to at least part of at least one enhanced area.

In an embodiment of any of the above embodiments the formation of at least one enhanced area comprises the application of a susceptor to the surface of the support in at least part of at least one enhanced area. In this embodiment the susceptor is not applied to those parts of the support that are not part of an enhanced area.

In an embodiment of any of the above embodiments the susceptor is applied to substantially all of at least one enhanced area.

The application of the susceptor to part or all of one or more enhanced areas has the advantage, when the susceptor is caused to heat up during the use of the consumable, that the heating by the susceptor is limited to only those parts of the support where heating is intended, that is to only those parts of the enhanced areas to which the susceptor is applied. This increases the efficiency of the heating of the consumable because no parts of the support are heated which are not intended to be heated.

In an embodiment of any of the above embodiments the application of a susceptor to the support comprises the application of one or more preshaped portions of susceptor. The preshaped portions of susceptor are cut or otherwise preformed into one or more predetermined shapes prior to their application to the support. In some embodiments all the preshaped portions of susceptor are the same shape. In other embodiments each of the preshaped portions of susceptor is one of a number (where the number is greater than one) of different shapes.

In an embodiment of any of the above embodiments the preshaped portions of susceptor are applied to the support in a predetermined pattern. In some embodiments the predetermined pattern is one which includes two or more preshaped portions of susceptor applied to the same enhanced area of the support.

The arrangement of the one or more preshaped portions of the susceptor on the surface of the support can be optimised to minimise the energy requirement to achieve a predetermined level of heating of aerosol generating material applied to the support.

In an embodiment of any of the above embodiments the application of a susceptor to the support comprises application of a sheet of susceptor to the support, kiss cutting the susceptor to form at least one predetermined closed cut line in the susceptor, and removing the portions of susceptor that are not within a closed cut line, and the cut line coincides with or falls within the perimeter of the at least one enhanced areas. The cut line is closed when the cut line has no end or beginning. For example, a line describing a circle is closed because that line has no beginning or end. In some embodiments, the kiss cutting of the susceptor may include one or more other cut lines that are located within the area defined by a closed cutline.

In an embodiment of any of the above embodiments the susceptor comprises a metal or a metal alloy. In some embodiments the susceptor is a metal or metal alloy foil or film. For example, an aluminium foil or film.

In an embodiment of any of the above embodiments the method of the application of the susceptor to at least part of at least one enhanced area comprises the use of hot foil stamping techniques. Use of such techniques is advantageous because hot foil stamping techniques allow accurate placement of the foil with the result that there is a reduced need for the susceptor to be oversized to allow for any inaccuracies in application of the susceptor. This in turn leads to a reduction in the susceptor used and consequential economic and environmental savings.

A further advantage of the use of hot foil stamping techniques is that in embodiments in which the enhanced area is created by embossing or debossing, the embossing/debossing can be performed at the same time as the hot foil stamping by adapting the embossing or debossing tool to also perform the hot foil stamping. Such an arrangement has the further benefit of not requiring separate registration of the susceptor to the embossed or debossed area because the embossing or debossing and application of the susceptor takes place at the same time.

A susceptor is a material that is heatable by penetration with a varying magnetic field, such as an alternating magnetic field. The susceptor may be an electrically-conductive material, so that penetration thereof with a varying magnetic field causes induction heating of the susceptor by resistive heating as a result of electric eddy currents. The susceptor may be magnetic material, so that penetration thereof with a varying magnetic field causes magnetic hysteresis heating of the susceptor. The susceptor may be both electrically-conductive and magnetic, so that the susceptor is heatable by both heating mechanisms. The device that is configured to generate the varying magnetic field is referred to as a magnetic field generator.

The susceptor may comprise a ferromagnetic metal such as iron or an iron alloy such as steel or an iron nickel alloy. Some example ferromagnetic metals are a 400 series stainless steel such as grade 410 stainless steel, or grade 420 stainless steel, or grade 430 stainless steel, or stainless steel of similar grades. Alternatively, the susceptor may comprise a suitable non-magnetic, in particular paramagnetic, conductive material, such as aluminium. In a paramagnetic conductive material inductive heating occurs solely by resistive heating due to eddy currents. Alternatively, the susceptor may comprise a non-conductive ferrimagnetic material, such as a non-conductive ferrimagnetic ceramic. In that case, heat is only-generated by hysteresis losses. The susceptor may comprise a commercial alloy like Phytherm 230 (with a composition (in % by weight=wt %) with 50 wt % Ni, 10 wt % Cr and the rest Fe) or Phytherm 260 (with a composition with 50 wt % Ni, 9 wt % Cr and the rest Fe).

The susceptor may in some embodiments of any of the above embodiments be a metal foil, optionally an aluminium foil or a ferrous foil. Alternatively, the susceptor may in some embodiments of any of the above embodiments be any conductor that could be sprayed or vapor deposited on a material that forms the support.

In an embodiment of any of the above embodiments at least one enhanced area comprises two or more enhancements.

In an embodiment of any of the above embodiments the formation of at least one enhanced area comprises forming at least two separate enhanced areas.

In an embodiment of any of the above embodiments at least two separate enhanced areas of the at least two separate enhanced areas are distinguishable from each other by a human or automated observer. In this context, the human is understood to be a human of average eyesight who does not suffer from color blindness or a similar condition. In some embodiments the enhanced areas are of different shapes or colors.

In an embodiment of any of the above embodiments the application of aerosol generating material is application to at least part of each enhanced area of the support, and no application of aerosol generating material to portions of the support not forming an enhanced area.

In an embodiment of any of the above embodiments the application of aerosol generating material is application to the whole of each enhanced area of the support, and no application of aerosol generating material to portions of the support not forming an enhanced area.

In an embodiment of any of the above embodiments the application of aerosol generating material is application to the whole of each enhanced area of the support and at least part of the support which surrounds each enhanced area, and no application of aerosol generating material to the remaining portions of the support not forming an enhanced area. An advantage of this arrangement is that the aerosol generating material on the support surrounding each enhanced area will utilize any heat applied to the enhanced area and which travels out of the enhanced area by virtue of conduction. This maximises the aerosol production per Joule (J) of heat energy applied to the enhanced area.

In an embodiment of any of the above embodiments the at least part of the support which surrounds each enhanced area is a zone extending less than 1 mm, less than 2 mm, less than 3 mm, less than 4 mm, less than 5 mm, less than 6 mm, less than 8 mm, or less than 10 mm from the perimeter of the enhanced area.

In an alternative embodiment of any of the above embodiments the application of aerosol generating material is application of aerosol generating material to substantially all of the support. This arrangement has the advantage that there is no need to accurately locate the aerosol generating material on the surface of the support so as to match the location of each enhanced area.

In an embodiment of any of the above embodiments the application of aerosol generating material comprises application of aerosol generating material using a transfer wheel.

In an embodiment of any of the above embodiments, the aerosol generating material is applied to a surface of the support as an aerosol generating material slurry.

In an embodiment of any of the above embodiments the method further comprises allowing or causing the aerosol generating material slurry to set, in which the aerosol generating material slurry sets to an aerosol generating material. The aerosol generating material may be caused to set using known aerosol generating material setting techniques.

In an embodiment of any of the above embodiments the aerosol generating material is applied as a set aerosol generating material.

In an embodiment of any of the above embodiments the application of the aerosol generating material comprises hot stamping the aerosol generating material onto the support. The hot stamping is performed using known hot stamping techniques. In some embodiments the hot stamping temperature is lower than the temperature at which the aerosol generating material starts to aerosolize.

In an embodiment of any of the above embodiments the aerosol generating material is an aerosol generating film.

In an embodiment of any of the above embodiments causing the formation of at least one enhanced area on the support and applying the aerosol generating material occur at substantially the same time. In some embodiments the aerosol generating material is hot stamped onto the support and the hot stamping also forms one or more enhanced areas on the support.

In an embodiment of any of the above embodiments the support comprises a sheet with a first and second surface, formation of least one enhanced area comprises formation of the at least one enhanced area on one or both of the first and second surfaces of the support, and the application of aerosol generating material is application of aerosol generating material to one or both of (i) at least part of the at least one enhanced area, and (ii) at least part of the portion of a surface corresponding in position to the position of the at least one enhanced area on the other surface. This arrangement has the advantage that aerosol generating material can be applied to one or both surfaces of the support. When aerosol generating material is applied to both the first and second surfaces of the support a greater quantity of aerosol generating material may be associated with an enhanced area than if the aerosol generating material is applied to only one surface of the support.

In an embodiment of any of the above embodiments the support comprises a sheet with a first and second surface, and formation of least one enhanced area comprises formation of the at least one enhanced area on first and second surfaces of the support.

According to a second aspect of the present disclosure there is provided a consumable for use with an apparatus for heating a non-combustible aerosol provision system, in which the consumable comprises a support, at least one enhanced area on the support, and aerosol generating material, and the aerosol generating material is supported on the support in at least one position that corresponds to at least part of at least one enhanced area.

In an embodiment of any of the above embodiments the aerosol generating material has the form of an aerosol generating film.

In an embodiment of any of the above embodiments the enhancement in at least one enhanced area of the support is that at least part of at least one enhanced area of the support has an increased rigidity relative to the portions of the support that are not part of an enhanced area.

In an embodiment of any of the above embodiments the enhancement in at least one enhanced area of the support is that at least part of at least one enhanced area has an increased thermal transmissivity relative to the portions of the support that are not part of an enhanced area.

In an embodiment of any of the above embodiments the enhancement in at least one enhanced area of the support is that at least part of at least one enhanced area is embossed or debossed.

In an embodiment of any of the above embodiments the enhancement in at least one enhanced area of the support is that at least part of at least one enhanced area has an increased thickness relative to the portions of the support that are not part of an enhanced area.

In an embodiment of any of the above embodiments the enhancement in at least one enhanced area of the support is that at least one enhanced area comprises a susceptor.

In an embodiment of any of the above embodiments the susceptor is a metal or a metal alloy. In some embodiments the susceptor is a metal or metal alloy foil or film. For example an aluminium foil or film.

In an embodiment of any of the above embodiments the susceptor has an outer perimeter which matches the shape and dimensions of the perimeter of the enhanced area to which the susceptor is applied.

In an embodiment of any of the above embodiments the susceptor covers at least part of the enhanced area and the outer perimeter of the enhanced area encompasses the susceptor.

In an embodiment of any of the above embodiments at least one enhanced area comprises two or more enhancements.

In an embodiment of any of the above embodiments there are at least two separate enhanced areas.

In an embodiment of any of the above embodiments at least two separate enhanced areas of the at least two separate enhanced areas are distinguishable from each other by a human or automated observer.

In an embodiment of any of the above embodiments aerosol generating material is supported on at least part of each enhanced area, and no aerosol generating material is supported on portions of the support not forming an enhanced area.

In an embodiment of any of the above embodiments the whole of each enhanced area supports aerosol generating material, and no aerosol generating material is supported on portions of the support not forming an enhanced area.

In an embodiment of any of the above embodiments the whole of each enhanced area and a surrounding zone or at least part of the support which surrounds each enhanced area supports aerosol generating material and no aerosol generating material is supported on the portions of the support that do not form an enhanced area or a surrounding zone.

In an embodiment of any of the above embodiments the at least part of the support which surrounds each enhanced area is a zone extending less than 1 mm, less than 2 mm, less than 3 mm, less than 4 mm, less than 5 mm, less than 6 mm, less than 8 mm, or less than 10 mm from the perimeter of the enhanced area.

In an embodiment of any of the above embodiments substantially all of the support supports the aerosol generating material. In this context, substantially all of the support is to be understood to reference, where the support has only one surface on which one or more enhanced areas are formed, all of that surface, or where the support has two or more surfaces on which one or more enhanced areas are formed, all of those surfaces.

In an embodiment of any of the above embodiments the aerosol generating material comprises an aerosol generating gel.

In an embodiment of any of the above embodiments the support comprises a sheet with a first and second surface, at least one enhanced area is located on one or both of the first and second surfaces of the support, and aerosol generating material is supported on one or both of (i) at least part of the at least one enhanced area, and (ii) at least part of the portion of a surface corresponding in position to the position of the enhanced area on the other surface.

In an embodiment of any of the above embodiments the support comprises a sheet with a first and second surface, and at least one enhanced area is located on each of the first and second surfaces of the support

In an embodiment of any of the above embodiments the aerosol-generating material comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, terpenes of non-cannabinoid origin, thiene, vitamins such as B6 or B12 or C, melatonin, cannabinoids, or constituents, derivatives, or combinations thereof. The active substance may comprise one or more constituents, derivatives or extracts of tobacco, cannabis or another botanical.

The active substance may comprise one or more constituents, derivatives or extracts of cannabis, such as one or more cannabinoids or terpenes.

In some embodiments, the active substance comprises nicotine. In some embodiments, the active substance comprises caffeine, melatonin or vitamin B12.

The active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the aerosol-generating material comprises a flavor or flavorant.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol generating material comprises an aerosol generating agent. In some embodiments the aerosol generating agent may comprise one or more constituents capable of forming an aerosol. In some embodiments, the aerosol generating agent may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. In particular examples, the aerosol generating agent comprises glycerol.

In some embodiments, the aerosol generating agent comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate.

In some embodiments, the aerosol generating material may comprise from about 0.1 wt %, 0.5 wt %, 1 wt %, 3 wt %, 5 wt %, 7 wt % or 10% to about 50 wt %, 45 wt %, 40 wt %, 35 wt %, 30 wt % or 25 wt % of an aerosol generating agent (all calculated on a dry weight basis).

The aerosol generating agent may act as a plasticiser. For example, the aerosol generating material may comprise 0.5-40 wt %, 3-35 wt % or 10-25 wt % of an aerosol generating agent.

In some embodiments, the aerosol generating material may comprise from about 5 wt %, 10 wt %, 20 wt %, 25 wt %, 27 wt % or 30 wt % to about 60 wt %, 55 wt %, 50 wt %, 45 wt %, 40 wt %, or 35 wt % of an aerosol generating agent (DWB). For example, the aerosol generating material may comprise 10-60 wt %, 20-50 wt %, 25-40 wt % or 30-35 wt % of an aerosol generating agent.

In some embodiments, the aerosol generating material may comprise up to about 80 wt %, such as about 40 to 80 wt %, 40 to 75 wt %, 50 to 70 wt %, or 55 to 65 wt % of an aerosol generating agent (DWB).

The aerosol generating material may also comprise a gelling agent. In some embodiments, the gelling agent comprises a hydrocolloid. In some embodiments, the gelling agent comprises one or more compounds selected from the group comprising alginates, pectins, starches (and derivatives), celluloses (and derivatives), gums, silica or silicones compounds, clays, polyvinyl alcohol and combinations thereof. For example, in some embodiments, the gelling agent comprises one or more of alginates, pectins, hydroxyethyl cellulose, hydroxypropyl cellulose, carboxymethylcellulose, pullulan, xanthan gum guar gum, carrageenan, agarose, acacia gum, fumed silica, PDMS, sodium silicate, kaolin and polyvinyl alcohol. In some cases, the gelling agent comprises alginate and/or pectin, and may be combined with a setting agent (such as a calcium source) during formation of the aerosol generating material. In some cases, the aerosol generating material may comprise a calcium-crosslinked alginate and/or a calcium-crosslinked pectin.

In some embodiments, the gelling agent comprises one or more compounds selected from cellulosic gelling agents, non-cellulosic gelling agents, guar gum, acacia gum and mixtures thereof.

In some embodiments, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

In some embodiments, the gelling agent comprises alginate, and the alginate is present in the aerosol generating material in an amount of from 10-30 wt % of the aerosol generating material (calculated on a dry weight basis). In some embodiments, alginate is the only gelling agent present in the aerosol generating material. In other embodiments, the gelling agent comprises alginate and at least one further gelling agent, such as pectin.

In some embodiments, the aerosol generating material comprises from about 1 wt %, 5 wt %, 10 wt %, 15 wt %, 20 wt % or 25 wt % to about 60 wt %, 50 wt %, 45 wt %, 40 wt % or 35 wt % of a gelling agent (all calculated on a dry weight basis). For example, the aerosol generating material may comprise 1-50 wt %, 5-45 wt %, 10-40 wt % or 20-35 wt % of a gelling agent.

In some embodiments, the aerosol generating material comprises from about 20 wt % 22 wt %, 24 wt % or 25 wt % to about 30 wt %, 32 wt % or 35 wt % of a gelling agent (all calculated on a dry weight basis). For example, the aerosol generating material may comprise 20-35 wt % or 25-30 wt % of a gelling agent.

In some cases, the aerosol generating material may comprise from about 1 wt %, 5 wt %, 10 wt %, 15 wt % or 20 wt % to about 60 wt %, 50 wt %, 40 wt %, 30 wt % or 25 wt % of a gelling agent (DWB). For example, the aerosol generating material may comprise 10-40 wt %, 15-30 wt % or 20-25 wt % of a gelling agent (DWB).

In examples, the aerosol generating material comprises gelling agent and filler, taken together, in an amount of from about 10 wt %, 20 wt %, 25 wt %, 30 wt %, or 35 wt % to about 60 wt %, 55 wt %, 50 wt %, or 45 wt % of the aerosol generating material. In examples, the aerosol generating material comprises gelling agent and filler, taken together, in an amount of from about 20 to 60 wt %, 25 to 55 wt %, 30 to 50 wt %, or 35 to 45 wt % of the aerosol generating material.

In examples, the aerosol generating material comprises gelling agent (i.e. without taking into account the amount of filler) in an amount of from about 5 wt %, 10 wt %, 15 wt %, 20 wt %, 25 wt %, 30 wt %, or 35 wt % to about 60 wt %, 55 wt %, 50 wt %, or 45 wt % of the aerosol generating material. In examples, the aerosol generating material comprises gelling agent (i.e. without taking into account the amount of filler) in an amount of from about 5 to 60 wt %, 20 to 60 wt %, 25 to 55 wt %, 30 to 50 wt %, or 35 to 45 wt % of the aerosol generating material.

In some examples, alginate is comprised in the gelling agent in an amount of from about 5 to 40 wt % of the aerosol generating material, or 15 to 40 wt %. That is, the aerosol generating material comprises alginate in an amount of about 5 to 40 wt % by dry weight of the aerosol generating material, or 15 to 40 wt %. In some examples, the aerosol generating material comprises alginate in an amount of from about 20 to 40 wt %, or about 15 wt % to 35 wt % of the aerosol generating material.

In some examples, pectin is comprised in the gelling agent in an amount of from about 3 to 15 wt % of the aerosol generating material. That is, the aerosol generating material comprises pectin in an amount of from about 3 to 15 wt % by dry weight of the aerosol generating material. In some examples, the aerosol generating material comprises pectin in an amount of from about 5 to 10 wt % of the aerosol generating material.

In some examples, guar gum is comprised in the gelling agent in an amount of from about 3 to 40 wt % of the aerosol generating material. That is, the aerosol generating material comprises guar gum in an amount of from about 3 to 40 wt % by dry weight of the aerosol generating material. In some examples, the aerosol generating material comprises guar gum in an amount of from about 5 to 10 wt % of the aerosol generating material. In some examples, the aerosol generating material comprises guar gum in an amount of from about 15 to 40 wt % of the aerosol generating material, or from about 20 to 40 wt %, or from about 15 to 35 wt %.

In examples, the alginate is present in an amount of at least about 50 wt % of the gelling agent. In examples, the aerosol generating material comprises alginate and pectin, and the ratio of the alginate to the pectin is from 1:1 to 10:1. The ratio of the alginate to the pectin is typically >1:1, i.e. the alginate is present in an amount greater than the amount of pectin.

In examples, the ratio of alginate to pectin is from about 2:1 to 8:1, or about 3:1 to 6:1, or is approximately 4:1.

The aerosol generating material may be formed by (a) forming a slurry comprising components of the aerosol generating material or precursors thereof, (b) forming a layer of the slurry, (c) setting the slurry to form a gel, and (d) drying to form an aerosol generating material.

The (b) forming a layer of the slurry typically comprises spraying, casting or extruding the slurry. In examples, the slurry layer is formed by electrospraying the slurry. In examples, the slurry layer is formed by casting the slurry.

In some examples, (b) and/or (c) and/or (d), at least partially, occur simultaneously (for example, during electrospraying). In some examples, (b), (c) and (d) occur sequentially.

In some examples, the slurry is applied to a support. The layer may be formed on a support.

In examples, the slurry comprises gelling agent, aerosol-former material and active substance. The slurry may comprise these components in any of the proportions given herein in relation to the composition of the aerosol generating material. For example, the slurry may comprise (on a dry weight basis):
gelling agent and, optionally, filler, wherein the amount of gelling agent and filler taken together is about 10 to 60 wt % of the slurry;
aerosol-former material in an amount of about 40 to 80 wt % of the slurry; and
optionally, active substance in an amount of up to about 20 wt % of the slurry.

The setting the gel (c) may comprise supplying a setting agent to the slurry. For example, the slurry may comprise sodium, potassium or ammonium alginate as a gel-precursor, and a setting agent comprising a calcium source (such as calcium chloride), may be added to the slurry to form a calcium alginate gel.

In examples, the setting agent comprises or consists of calcium acetate, calcium formate, calcium carbonate, calcium hydrogencarbonate, calcium chloride, calcium lactate, or a combination thereof. In some examples, the setting agent comprises or consists of calcium formate and/or calcium lactate. In particular examples, the setting agent comprises or consists of calcium formate. The inventors have identified that, typically, employing calcium formate as a setting agent results in an aerosol generating material having a greater tensile strength and greater resistance to elongation.

The total amount of the setting agent, such as a calcium source, may be 0.5-5 wt % (calculated on a dry weight basis). Suitably, the total amount may be from about 1 wt %, 2.5 wt % or 4 wt % to about 4.8 wt % or 4.5 wt %. The inventors have found that the addition of too little setting agent may result in an aerosol generating material which does not stabilise the aerosol generating material components and results in these components dropping out of the aerosol generating material. The inventors have found that the addition of too much setting agent results in an aerosol generating material that is very tacky and consequently has poor handleability.

When the aerosol generating material does not contain tobacco, a higher amount of setting agent may need to be applied. In some cases the total amount of setting agent may therefore be from 0.5-12 wt % such as 5-10 wt %, calculated on a dry weight basis. Suitably, the total amount may be from about 5 wt %, 6 wt % or 7 wt % to about 12 wt % or 10 wt %. In this case the aerosol generating material will not generally contain any tobacco.

In examples, supplying the setting agent to the slurry comprises spraying the setting agent on the slurry, such as a top surface of the slurry.

Alginate salts are derivatives of alginic acid and are typically high molecular weight polymers (10-600 kDa). Alginic acid is a copolymer of β-D-mannuronic (M) and α-L-guluronic acid (G) units (blocks) linked together with (1,4)-glycosidic bonds to form a polysaccharide. On addition of calcium cations, the alginate crosslinks to form a gel. It has been found that alginate salts with a high G monomer content more readily form a gel on addition of the calcium source. In some cases therefore, the gel-precursor may comprise an alginate salt in which at least about 40%, 45%, 50%, 55%, 60% or 70% of the monomer units in the alginate copolymer are α-L-guluronic acid (G) units.

In examples, the drying (d) removes from about 50 wt %, 60 wt %, 70 wt %, 80 wt % or 90 wt % to about 80 wt %, 90 wt % or 95 wt % (WWB) of water in the slurry.

In examples, the drying (d) reduces the cast material thickness by at least 80%, suitably 85% or 87%. For instance, the slurry is cast at a thickness of 2 mm, and the resulting dried aerosol generating material has a thickness of 0.2 mm.

In some examples, the slurry solvent consists essentially of or consists of water. In some examples, the slurry comprises from about 50 wt %, 60 wt %, 70 wt %, 80 wt % or 90 wt % of solvent (WWB).

In examples where the solvent consists of water, the dry weight content of the slurry may match the dry weight content of the aerosol generating material. Thus, the discussion herein relating to the solid composition is explicitly disclosed in combination with the slurry aspect of the invention.

The aerosol generating material may comprises a flavor. Suitably, the aerosol generating material may comprise up to about 80 wt %, 70 wt %, 60 wt %, 55 wt %, 50 wt % or 45 wt % of a flavor. In some cases, the aerosol generating material may comprise at least about 0.1 wt %, 1 wt %, 10 wt %, 20 wt %, 30 wt %, 35 wt % or 40 wt % of a flavor (all calculated on a dry weight basis). For example, the aerosol generating material may comprise 1-80 wt %, 10-80 wt %, 20-70 wt %, 30-60 wt %, 35-55 wt % or 30-45 wt % of a flavor. In some cases, the flavor comprises, consists essentially of or consists of menthol.

The aerosol generating material may comprise a filler.

In some embodiments, the aerosol generating material comprises less than 60 wt % of a filler, such as from 1 wt % to 60 wt %, or 5 wt % to 50 wt %, or 5 wt % to 30 wt %, or 10 wt % to 20 wt %.

In other embodiments, the aerosol generating material comprises less than 20 wt %, suitably less than 10 wt % or less than 5 wt % of a filler. In some cases, the aerosol generating material comprises less than 1 wt % of a filler, and in some cases, comprises no filler.

In some such cases the aerosol generating material comprises at least 1 wt % of the filler, for example, at least 5 wt %, at least 10 wt %, at least 20 wt % at least 30 wt %, at least 40 wt %, or at least 50 wt % of the filler. In some embodiments, the aerosol generating material comprises 5-25 wt % of the filler.

The filler, if present, may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may comprise one or more organic filler materials such as wood pulp, cellulose and cellulose derivatives (such as methylcellulose, hydroxypropyl cellulose, and carboxymethyl cellulose (CMC)). In particular cases, the aerosol generating material comprises no calcium carbonate such as chalk.

In particular embodiments which include filler, the filler is fibrous. For example, the filler may be a fibrous organic filler material such as wood pulp, hemp fiber, cellulose or cellulose derivatives (such as methylcellulose, hydroxypropyl cellulose, and carboxymethyl cellulose (CMC)).

Without wishing to be bound by theory, it is believed that including fibrous filler in an aerosol generating material may increase the tensile strength of the material. This may be particularly advantageous in examples wherein the aerosol generating material is provided as a sheet, such as when an aerosol generating material sheet circumscribes a rod of aerosolizable material.

In some embodiments, the aerosol generating material does not comprise tobacco fibers. In particular embodiments, the aerosol generating material does not comprise fibrous material.

The aerosol-generating material may comprise one or more active substances and/or flavors, one or more aerosol-former materials, and optionally one or more other functional material.

In some embodiments, the aerosol generating material additionally comprises an active substance. For example, in some cases, the aerosol generating material additionally comprises a tobacco material and/or nicotine. In some embodiments, the aerosol generating material comprises powdered tobacco and/or nicotine and/or a tobacco extract.

In some cases, the aerosol generating material may comprise 5-60 wt % (calculated on a dry weight basis) of a tobacco material and/or nicotine. In some cases, the aerosol generating material may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of an active substance. In some cases, the aerosol generating material may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of a tobacco material. For example, the aerosol generating material may comprise 10-50 wt %, 15-40 wt % or 20-35 wt % of a tobacco material. In some cases, the aerosol generating material may comprise from about 1 wt %, 2 wt %, 3 wt % or 4 wt % to about 20 wt %, 18 wt %, 15 wt % or 12 wt % (calculated on a dry weight basis) of nicotine. For example, the aerosol generating material may comprise 1-20 wt %, 2-18 wt % or 3-12 wt % of nicotine.

In some cases, the aerosol generating material comprises an active substance such as tobacco extract. In some cases, the aerosol generating material may comprise 5-60 wt % (calculated on a dry weight basis) of tobacco extract. In some cases, the aerosol generating material may comprise from about 5 wt %, 10 wt %, 15 wt %, 20 wt % or 25 wt % to about 60 wt %, 50 wt %, 45 wt %, 40 wt %, 35 wt %, or 30 wt % (calculated on a dry weight basis) tobacco extract. For example, the aerosol generating material may comprise 10-50 wt %, 15-40 wt % or 20-35 wt % of tobacco extract. The tobacco extract may contain nicotine at a concentration such that the aerosol generating material comprises 1 wt % 1.5 wt %, 2 wt % or 2.5 wt % to about 6 wt %, 5 wt %, 4.5 wt % or 4 wt % (calculated on a dry weight basis) of nicotine. In some cases, there may be no nicotine in the aerosol generating material other than that which results from the tobacco extract.

In some embodiments the aerosol generating material comprises no tobacco material but does comprise nicotine. In some such cases, the aerosol generating material may comprise from about 1 wt %, 2 wt %, 3 wt % or 4 wt % to about 20 wt %, 18 wt %, 15 wt % or 12 wt % (calculated on a dry weight basis) of nicotine. For example, the aerosol generating material may comprise 1-20 wt %, 2-18 wt % or 3-12 wt % of nicotine.

In some cases, the total content of active substance and/or flavor may be at least about 0.1 wt %, 1 wt %, 5 wt %, 10 wt %, 20 wt %, 25 wt % or 30 wt %. In some cases, the total content of active substance and/or flavor may be less than about 90 wt %, 80 wt %, 70 wt %, 60 wt %, 50 wt % or 40 wt % (all calculated on a dry weight basis).

In some cases, the total content of tobacco material, nicotine and flavor may be at least about 0.1 wt %, 1 wt %, 5 wt %, 10 wt %, 20 wt %, 25 wt % or 30 wt %. In some cases, the total content of active substance and/or flavor may be less than about 90 wt %, 80 wt %, 70 wt %, 60 wt %, 50 wt % or 40 wt % (all calculated on a dry weight basis).

The aerosol-generating composition may comprise one or more active substances. In examples, the aerosol generating material comprises one or more active substances, e.g. up to about 20 wt % of the aerosol generating material. In examples, the aerosol generating material comprises active substance in an amount of from about 1 wt %, 5 wt %, 10 wt %, or 15 wt % to about 20 wt %, 15 wt %, 15 wt % or 5 wt % of the aerosol generating material.

The active substance may comprise a physiologically and/or olfactory active substance which is included in the aerosol-generating composition in order to achieve a physiological and/or olfactory response.

Tobacco material may be present in the aerosol-generating composition in an amount of from about 50 to 95 wt %, or about 60 to 90 wt %, or about 70 to 90 wt %, or about 75 to 85 wt %.

The tobacco material may be present in any format, but is typically fine-cut (e.g. cut into narrow shreds). Fine-cut tobacco material may advantageously be blended with the aerosol generating material to provide an aerosol-generating composition which has an even dispersion of tobacco material and aerosol generating material throughout the aerosol-generating composition.

In examples, the tobacco material comprises one or more of ground tobacco, tobacco fiber, cut tobacco, extruded tobacco, tobacco stem, reconstituted tobacco and/or tobacco extract. Surprisingly, the inventors have identified that it is possible to use a relatively large amount of lamina tobacco in the aerosol-generating composition and still provide an acceptable aerosol when heated by a non-combustible aerosol provision system. Lamina tobacco typically provides superior sensory characteristics. In examples, the tobacco material comprises lamina tobacco in an amount of at least about 50 wt %, 60 wt %, 70 wt %, 80 wt %, 85 wt %, 90 wt %, or 95 wt % of the tobacco material. In particular examples, the tobacco material comprises cut tobacco in an amount of at least about 50 wt %, 60 wt %, 70 wt %, 80 wt %, 85 wt %, 90 wt %, or 95 wt % of the tobacco material.

The tobacco used to produce tobacco material may be any suitable tobacco, such as single grades or blends, cut rag or whole leaf, including Virginia and/or Burley and/or Oriental.

In some embodiments the one or more other functional materials may comprise one or more of pH regulators, coloring agents, preservatives, binders, fillers, stabilizers, and/or antioxidants.

In some cases, the aerosol generating material may additionally comprise an emulsifying agent, which emulsified molten flavor during manufacture. For example, the aerosol generating material may comprise from about 5 wt % to about 15 wt % of an emulsifying agent (calculated on a dry weight basis), suitably about 10 wt %. The emulsifying agent may comprise acacia gum.

In some embodiments, the aerosol generating material is a hydrogel and comprises less than about 20 wt % of water calculated on a wet weight basis. In some cases, the hydrogel may comprise less than about 15 wt %, 12 wt % or 10 wt % of water calculated on a wet weight basis. In some cases, the hydrogel may comprise at least about 1 wt %, 2 wt % or at least about 5 wt % of water (WWB).

The aerosol generating material may have any suitable water content, such as from 1 wt % to 15 wt %. Suitably, the water content of the aerosol generating material is from about 5 wt %, 7 wt % or 9 wt % to about 15 wt %, 13 wt % or 11 wt % (WWB), most suitably about 10 wt %. The water content of the aerosol generating material may, for example, be determined by Karl-Fischer-titration or Gas Chromatography with Thermal Conductivity Detector (GC-TCD).

In some cases, the aerosol generating material may consist essentially of, or consist of a gelling agent, water, an aerosol generating agent, a flavor, and optionally an active substance.

In some cases, the aerosol generating material may consist essentially of, or consist of a gelling agent, water, an aerosol generating agent, a flavor, and optionally a tobacco material and/or a nicotine source.

In examples, the aerosol generating material consists essentially of, or consists of a gelling agent, aerosol generating agent, active substance, and water. In examples, the aerosol generating material consists essentially of, or consists of a gelling agent, aerosol generating agent, and water.

In examples, the aerosol generating material does not comprise a flavorant; in particular examples, the aerosol generating material does not comprise an active substance.

In some embodiments the aerosol generating material comprises an aerosol generating material, the aerosol generating material comprising:
1-60 wt % of a gelling agent;
0.1-50 wt % of an aerosol generating agent; and
0.1-80 wt % of a flavor;
   wherein these weights are calculated on a dry weight basis

In some embodiments, the aerosol generating material comprises 1-80 wt % of a flavor (dry weight basis).

In some embodiments, the aerosol generating material comprising:
1-50 wt % of a gelling agent;
0.1-50 wt % of an aerosol generating agent; and
30-60 wt % of a flavor;
   wherein these weights are calculated on a dry weight basis.

In alternative embodiments of the aerosol generating material, the aerosol generating material comprises an aerosol generating material, the aerosol generating material comprising:
1-60 wt % of a gelling agent;
5-60 wt % of an aerosol generating agent; and
10-60 wt % of a tobacco extract;
   wherein these weights are calculated on a dry weight basis.

In some embodiments, the aerosol generating material comprises:
1-60 wt % of a gelling agent;
20-60 wt % of an aerosol generating agent; and
10-60 wt % of a tobacco extract;
   wherein these weights are calculated on a dry weight basis.

In some embodiments, the aerosol generating material comprises 20-35 wt % of the gelling agent; 10-25 wt % of the aerosol-former material; 5-25 wt % of the filler comprising fibers; and 35-50 wt % of the flavorant and/or active substance.

In some cases, the aerosol generating material may consist essentially of, or consist of a gelling agent, an aerosol generating agent a tobacco extract, water, and optionally a flavor. In some cases, the aerosol generating material may consist essentially of, or consist of glycerol, alginates and/or pectins, a tobacco extract and water.

In some embodiments, the aerosol generating material may have the following composition (DWB): gelling agent (preferably comprising alginate) in an amount of from about 5 wt % to about 40 wt %, or about 10 wt % to 30 wt %, or about 15 wt % to about 25 wt %; tobacco extract in an amount of from about 30 wt % to about 60 wt %, or from about 40 wt % to 55 wt %, or from about 45 wt % to about 50 wt %; aerosol generating agent (preferably comprising glycerol) in an amount of from about 10 wt % to about 50 wt %, or from about 20 wt % to about 40 wt %, or from about 25 wt % to about 35 wt % (DWB).

In one embodiment, the aerosol generating material comprises about 20 wt % alginate gelling agent, about 48 wt % Virginia tobacco extract and about 32 wt % glycerol (DWB).

The “thickness” of the aerosol generating material describes the shortest distance between a first surface and a second surface. In embodiments where the aerosol generating material is in the form of a sheet, the thickness of the aerosol generating material is the shortest distance between a first planar surface of the sheet and a second planar surface of the sheet which opposes the first planar surface of the sheet.

In some cases, the aerosol-forming aerosol generating material layer has a thickness of about 0.015 mm to about 1.5 mm, suitably about 0.05 mm to about 1.5 mm or 0.05 mm to about 1.0 mm. Suitably, the thickness may be in the range of from about 0.1 mm or 0.15 mm to about 1.0 mm, 0.5 mm or 0.3 mm.

In some cases, the aerosol generating material may have a thickness of about 0.015 mm to about 1.0 mm. Suitably, the thickness may be in the range of about 0.05 mm, 0.1 mm or 0.15 mm to about 0.5 mm or 0.3 mm.

A material having a thickness of 0.2 mm is particularly suitable. The aerosol generating material may comprise more than one layer, and the thickness described herein refers to the aggregate thickness of those layers.

It has been found that if the aerosol-generating material is too thick, then heating efficiency is compromised. This adversely affects the power consumption in use. Conversely, if the aerosol-generating material is too thin, it is difficult to manufacture and handle; a very thin material is harder to cast and may be fragile, compromising aerosol formation in use.

The thickness stipulated herein is a mean thickness for the material. In some cases, the aerosol generating material thickness may vary by no more than 25%, 20%, 15%, 10%, 5% or 1%.

In some examples, the aerosol generating material in sheet form may have a tensile strength of from around 200 N/m to around 900 N/m. In some examples, such as where the aerosol generating material does not comprise a filler, the aerosol generating material may have a tensile strength of from 200 N/m to 400 N/m, or 200 N/m to 300 N/m, or about 250 N/m.

Such tensile strengths may be particularly suitable for embodiments wherein the aerosol generating material is formed as a sheet and then shredded and incorporated into an aerosol generating article. In some examples, such as where the aerosol generating material comprises a filler, the aerosol generating material may have a tensile strength of from 600 N/m to 900 N/m, or from 700 N/m to 900 N/m, or around 800 N/m. Such tensile strengths may be particularly suitable for embodiments wherein the aerosol generating material is included in an aerosol generating article/assembly as a rolled sheet, suitably in the form of a tube.

In some examples, the aerosol generating material in sheet form may have a tensile strength of from around 200 N/m to around 2600 N/m. In some examples, the aerosol generating material may have a tensile strength of from 600 N/m to 2000 N/m, or from 700 N/m to 1500 N/m, or around 1000 N/m. Such tensile strengths may be particularly suitable for embodiments wherein the aerosol-generating material comprising the aerosol generating material is formed and incorporated into an aerosol-generating consumable as a sheet.

The aerosol generating material comprising the aerosol generating material may have any suitable area density, such as from 30 g/m² to 120 g/m². In some cases, the sheet may have a mass per unit area of 80-120 g/m², or from about 70 to 110 g/m², or particularly from about 90 to 110 g/m², or suitably about 100 g/m² (so that it has a similar density to cut rag tobacco and a mixture of these substances will not readily separate). In some cases, the sheet may have a mass per unit area of about 30 to 70 g/m², 40 to 60 g/m², or 25-60 g/m² and may be used to wrap an aerosolizable material such as tobacco.

All percentages by weight described herein (denoted wt %) are calculated on a dry weight basis, unless explicitly stated otherwise. All weight ratios are also calculated on a dry weight basis. A weight quoted on a dry weight basis refers to the whole of the extract or slurry or material, other than the water, and may include components which by themselves are liquid at room temperature and pressure, such as glycerol. Conversely, a weight percentage quoted on a wet weight basis refers to all components, including water.

The aerosol generating material may comprise a colorant. The addition of a colorant may alter the visual appearance of the aerosol generating material. The presence of colorant in the aerosol generating material may enhance the visual appearance of the aerosol generating material and the aerosol-generating material. By adding a colorant to the aerosol generating material, the aerosol generating material may be color-matched to other components of the aerosol-generating material or to other components of an article comprising the aerosol generating material.

A variety of colorants may be used depending on the desired color of the aerosol generating material. The color of aerosol generating material may be, for example, white, green, red, purple, blue, brown or black. Other colors are also envisaged. Natural or synthetic colorants, such as natural or synthetic dyes, food-grade colorants and pharmaceutical-grade colorants may be used. In certain embodiments, the colorant is caramel, which may confer the aerosol generating material with a brown appearance. In such embodiments, the color of the aerosol generating material may be similar to the color of other components (such as tobacco material). In some embodiments, the addition of a colorant to the aerosol generating material renders it visually indistinguishable from other components in the aerosol-generating material.

The colorant may be incorporated during the formation of the aerosol generating material (e.g. when forming a slurry comprising the materials that form the aerosol generating material) or it may be applied to the aerosol generating material after its formation (e.g. by spraying it onto the aerosol generating material).

In some embodiments of any of the above embodiments, talcum powder, calcium carbonate powder or other powder is applied to the exposed surface of at least one discrete portion of aerosol-generating material. This may reduce the level of tackiness or adhesion of the aerosol-generating material.

In the following discussions of the accompanying drawings, where the same element is present in a more than one embodiment the same reference numeral is used for that element throughout, where there are similar elements similar reference numerals (the same numeral plus a multiple of 100) are used.

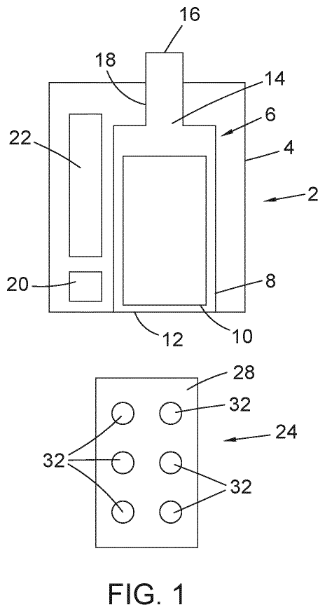

With reference to FIG. 1, an aerosol provision device 2 comprises a casing 4 within which is located a heater assembly 6. The heater assembly 6 is comprised of a heating chamber 8 and a heater 10. The heater 10 can be an electrical resistance heater or a magnetic field generator for use with a susceptor.

The heating chamber 8 defines an opening or mouth 12 at a first end of the heating chamber 8. At the opposite end of the heating chamber 8 is an aperture 14. The aperture 14 is in fluid communication with a mouth piece 16 via a conduit 18.

Also located within the casing 4 is a controller 20 which is in electronic communication with and controls the functioning of the heater 10. The controller 20 may include a memory (not shown) within which one or more tables relating to the operation of the heater 10 may be stored. The heater 10 and controller 20 are powered by a power source 22. The power source 22 is a rechargeable battery. In other embodiments the power source may be other appropriate sources of electrical power.

The aerosol provision device 2 is suitable for use with a consumable 24. The consumable 24 comprises of one or more discrete portions of aerosol-generating material 32 supported on first surface 28 of the consumable 24. The discrete portions of aerosol-generating material 32 are supported on the surface 28 in a square grid pattern. Other, non-illustrated embodiments of the consumable 24 may include more or less discrete portions of aerosol-generating material 32 than shown in FIG. 1, including a single portion of aerosol-generating material 32, and those portions may be distributed on the surface 28 in any pattern. The discrete portions of aerosol-generating material 32 are shown to have an approximately circular shape in FIG. 1, they may, in other embodiments, be of other shapes. Examples of how to produce or manufacture the consumable 24 are described below.

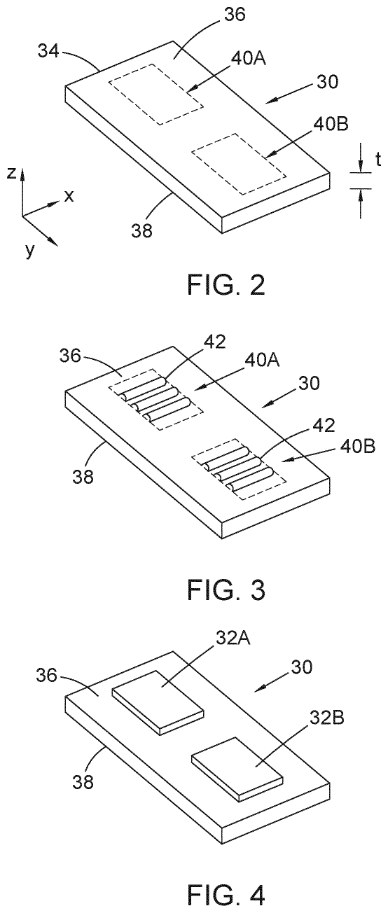

With reference to FIG. 2, to commence the manufacture of a consumable 24, a support 30 is provided. The support 30 comprises a longitudinally extending sheet of material, in the illustrated embodiment the support 30 is a sheet of card 34. In other unillustrated embodiments the material may be another suitable material, for example paper, card, paperboard, cardboard, reconstituted material, a plastics material, a ceramic material, a composite material, or glass. The length and width of the support 30 as shown in FIG. 2 is for illustrative purposes only. The support 30 may have different lengths and widths without departing from the scope of the present disclosure.

The card 34 has two major surfaces, a first surface 36 and a second surface 38. The distance between the first and second surfaces 36, 38 is thickness t.

The first surface 36 of the support 30 is designated as having first and second enhanced areas 40A, 40B.

With reference to FIG. 3, the support 30 is embossed using male and female dies (not shown) to form a plurality of parallel ridges 42 (only two of which are labelled for clarity) that extend across the enhanced areas 40A, 40B. The male and female dies were located adjacent the second face 38 and the first face 36 of the support 30 respectively. The dies were orientated so that the male and female profiles of the dies lined up with each other, and the dies were then impelled towards each other to cause the embossing of the support 30/formation of the ridges 42.

The creation of the ridges 42 in the support 30 causes the rigidity or resistance to bending of the enhanced areas 40A, 40B around at least the Y axis (shown in FIG. 2) to be increased relative to those portions of the support 30 that are not embossed.

With reference to FIG. 4, following the embossing of the support 30, distinct portions of aerosol generating material 32A, 32B are applied to enhanced areas 40A, 40B. The aerosol generating material 32A, 32B overlies the whole of the enhanced areas 40A, 40B and the ridges 42. The ridges 42 help the aerosol generating material adhere to the support 30. No aerosol generating material is applied to the support 30 other than to the enhanced areas 40A, 40B.

The portions of aerosol generating material 32A, 32B are, in the embodiment of the present disclosure shown in FIGS. 2 to 4, applied to the enhanced areas 40A, 40B in the form of a slurry. Once applied to the enhanced areas 40A, 40B the slurry needs to be dried or allowed to dry before the support 30 and aerosol generating material portions 32A, 32B can function as a consumable 24. Although the support 30 and aerosol generating material portions 32A, 32B could simply be allowed to dry over the course of time, such an approach may render the production of the media and portions of aerosol generating material 32, 232, 332 inefficient. Accordingly the aerosol generating material portions 32A, 32B can be dried using known methods of drying aerosol generating material slurry.

Once dry, the consumable 24 can be used to produce aerosol using an aerosol provision device 2.

In an alternative, non-illustrated example of the present disclosure, the embossing of the support 30 can be performed by mail and female dies where at least the female die is heated, and a sheet of aerosol generating material overlies the surface 36 of the support 30 in at least the enhanced areas 40A, 40B. The heating of the female die causes the portion of the aerosol generating material sheet overlying enhanced areas 40A, 40B to adhere to the surface 36 of support 30 at the same time as the ridges 42 are formed as a result of the configuration of the dies. Any aerosol generating material sheet not adhered to the enhanced areas 40A, 40B can then be pulled off the surface 36 of support 30.

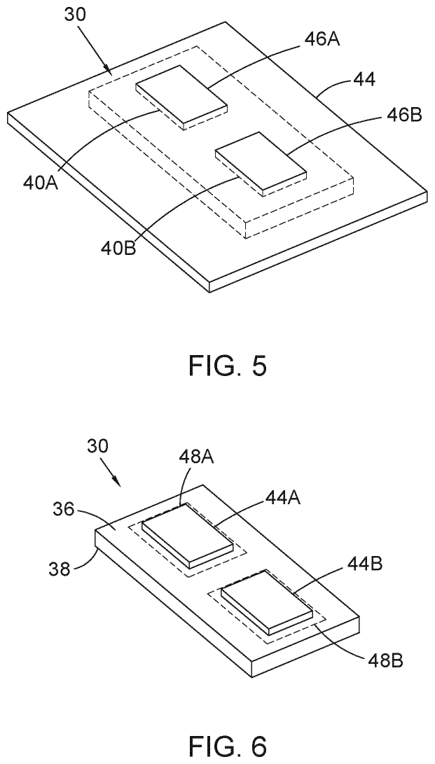

With reference to FIG. 5, in a second embodiment of the method of the present disclosure to manufacture a consumable 124, the support 30 of FIG. 2 has a layer 44 of susceptor material laid over the first surface 36 of the support 30. The susceptor layer 44 is a metal foil or film, for example an aluminium foil or film. The susceptor layer is reversibly fixed to the support 30 by an appropriate fixing material (not shown).

A kiss cutter, not shown, is caused to cut closed cut lines 46A, 46B into the susceptor layer 44. The closed cut lines 46A, 46B coincide with the outer perimeters of enhanced areas 40A, 40B. In other non-illustrated embodiments, the closed cut lines 46A, 46B are inside the outer perimeters of the enhanced areas 40A, 40B.

With reference to FIG. 6, once the closed cut lines 46A, 46B have been formed the portion of the susceptor layer 44 that is nor within a closed cut line 46A, 46B is removed from the support 30 leaving first and second susceptor portions 44A, 44B on the support 30 with first and second susceptor portions 44A, 44B overlying enhanced areas 40A, 40B.

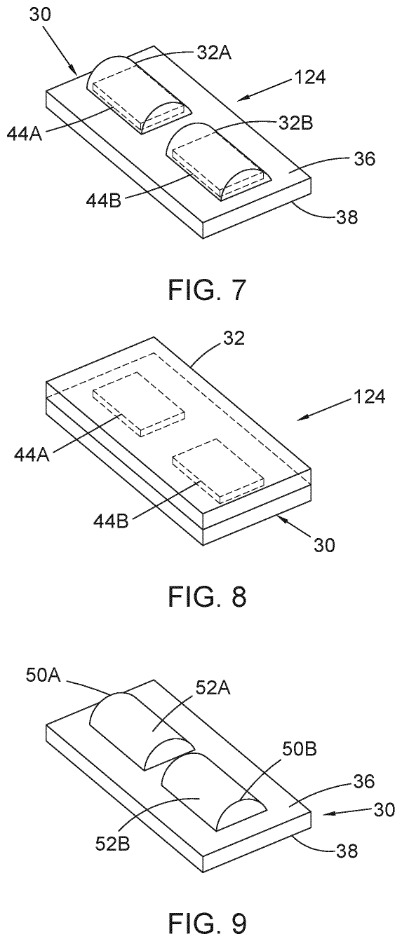

With reference to FIG. 7, distinct portions of aerosol generating material 32A, 32B are next applied to the susceptor portions 44A, 44B and surrounding zones or areas 48A, 48B. Surrounding zones 48A, 48B are zones of the first surface 36 that extend around the perimeter of the enhanced areas 40A, 40B. The aerosol generating material 32A, 32B thus overlies all of the surfaces of the susceptor portions 44A, 44B that are not facing the enhanced areas 40A, 40B. In some examples of the present disclosure, the zones 48A, 48B each extend less than 1 mm, less than 2 mm, less than 3 mm, less than 4 mm, less than 5 mm, less than 6 mm, less than 8 mm, or less than 10 mm from the perimeter of the enhanced areas 40A, 40B.

With reference to FIG. 8, an alternative example of the use of the support 30 and susceptor portions 44A, 44B is shown. In this example, aerosol generating material 32 is applied to the whole of the first surface 36 and susceptor portions 44A, 44B. The aerosol generating material 32 is applied to the first surface 36 and susceptor portions 44A, 44B using a transfer wheel (not shown).

In FIGS. 7 and 8, the portions of aerosol generating material 32A, 32B/32 are applied to the susceptor portions 44A, 44B and zones 48A, 48B/first surface 36 and susceptor portions 44A, 44B in the form of a slurry in a similar fashion to the application of the aerosol generating material discussed in connection with FIGS. 2 to 4. Once the slurry of aerosol generating material portions 32A, 32B/32 has dried the consumable 124 can be used to produce aerosol using an aerosol provision device 2.

The susceptor portions 44A, 44B in the consumable 124 have different functions in that consumable 124 dependent upon the nature of the aerosol provision device 2 with which the consumable is to be used.

When the aerosol provision device 2 is one that uses inductive heating to heat the consumable 124, the aerosol generator 10 is a magnetic field generator and the susceptor portions 44A, 44B are the susceptors that are heated by the magnetic field from the magnetic field generator. That heat then causes the aerosol generating material portions 32A, 32B to generate aerosol.

When the aerosol provision device 2 is one that uses resistive heating to heat the consumable 124, the aerosol generator 10 is a resistance heater and the susceptor portions 44A, 44B increase the heat/thermal transmissivity of the enhanced areas 40A, 40B by conducting heat energy across the enhanced areas 40A, 40B.

With reference to FIG. 9, in a third embodiment of the method of the present disclosure to manufacture a consumable 224, the support 30 of FIG. 2 has thickening elements 50A, 50B applied to the enhanced areas 40A, 40B. The thickening elements 50A, 50B are formed from an inert material and, in the illustrated example in FIG. 9, not of even thickness across the whole of enhanced areas 40A, 40B. In other non-illustrated examples, the thickening elements 50A, 50B are of even thickness across the whole or part of the enhanced areas 40A, 40B. The inert material of the thickening elements 50A, 50B is inert at the temperatures at which the consumable 224 will be used, and may, for example, be formed from a matrix of wood fibers and a suitable binder.

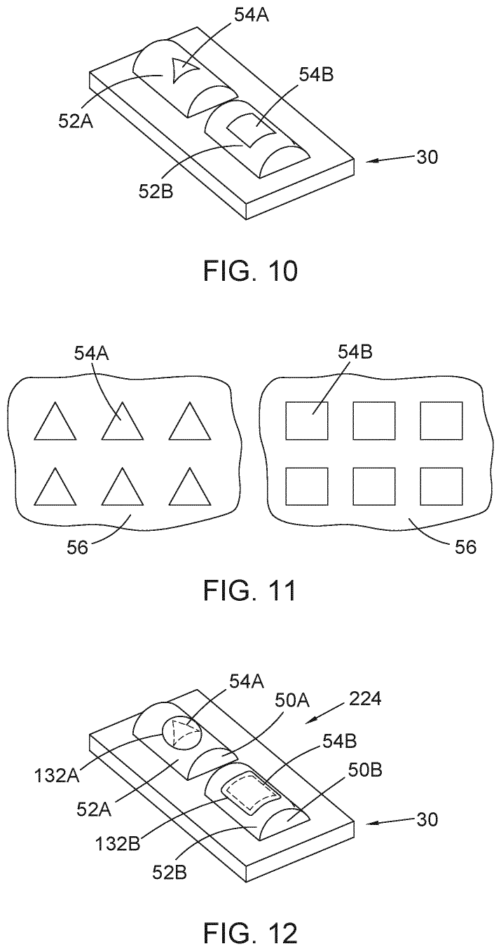

With reference to FIGS. 9 and 10, the thickening elements 50A, 50B have a surface 52A, 52B which faces away from the support 30. To the surface 52A, 52B of the thickening elements 50A, 50B portions 54A, 54B of susceptor material are attached using an appropriate fixing means. The susceptor portions 54A, 54B are formed from a metal foil or film for example an aluminium foil or film.

With reference to FIGS. 10 and 11, the susceptor portions 54A, 54B are of different shapes (a triangle and rectangle respectively) cut into shape whilst mounted on a backing sheet 56. The susceptor portions 54A, 54B are separated from their backing sheets 56 and attached to surfaces 52A, 52B respectively.

With reference to FIG. 12, distinct portions of aerosol generating material 132A, 132B are next applied to the susceptor portions 54A, 54B and to a portion of the surfaces 52A, 52B of the thickening elements 50A, 50B surrounding the susceptor portions 54A, 54B. The aerosol generating material 132A, 132B thus overlies the whole of the surfaces of the susceptor portions 54A, 54B that are not facing surfaces 52A, 52B of the thickening elements 50A, 50B.

The portions of aerosol generating material 132A, 132B are applied to the susceptor portions 54A, 54B and part of surfaces 52A, 52B of the thickening elements 50A, 50B in the form of a slurry in a similar fashion to the application of the aerosol generating material discussed in connection with FIGS. 2 to 4 above. Once the slurry of aerosol generating material portions 132A, 132B has dried the consumable 224 can be used to produce aerosol using an aerosol provision device 2.

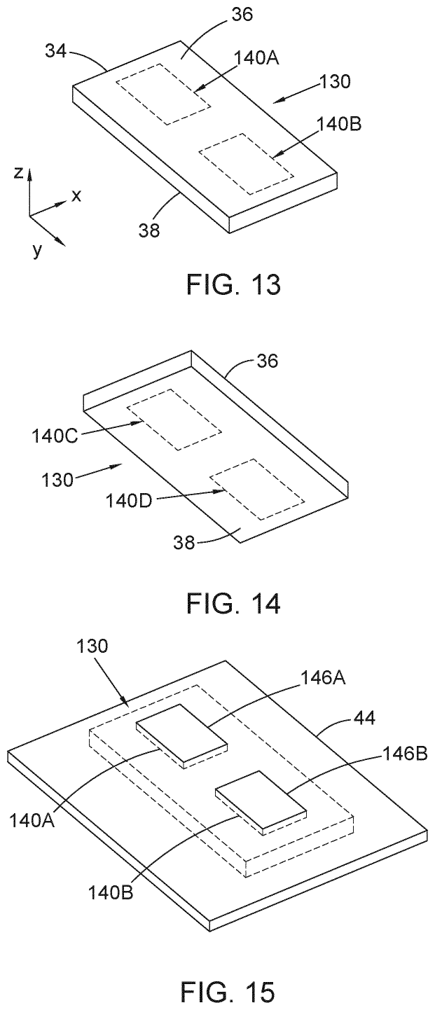

With reference to FIGS. 13 and 14, in a fourth embodiment of the method of the present disclosure to manufacture a consumable 324, a support 130 is provided. The support 130 comprises a longitudinally extending sheet of material, in the illustrated embodiment the support 130 is a sheet of card. In other unillustrated embodiments the material may be another suitable material, for example paper, card, paperboard, cardboard, reconstituted material, a plastics material, a ceramic material, a composite material, or glass. The length and width of the support 130 as shown in FIGS. 13 and 14 is for illustrative purposes only. The support 130 may have different lengths and widths without departing from the scope of the present disclosure.

The support 130 has two major surfaces, a first surface 36 and a second surface 38.

The first surface 36 of the support 130 is designated as having first and second enhanced areas 140A, 140B. The second surface 38 of the support 130 is designated as having third and fourth enhanced areas 140C, 140D. First and third enhanced areas 140A, 140C are located at the same positions of the first and second faces 36, 38 of the support 130 and thus correspond with each other. In a similar fashion, second and fourth enhanced areas 140B, 140D are located at the same positions of the first and second faces 36, 38 of the support 130 and thus correspond with each other.

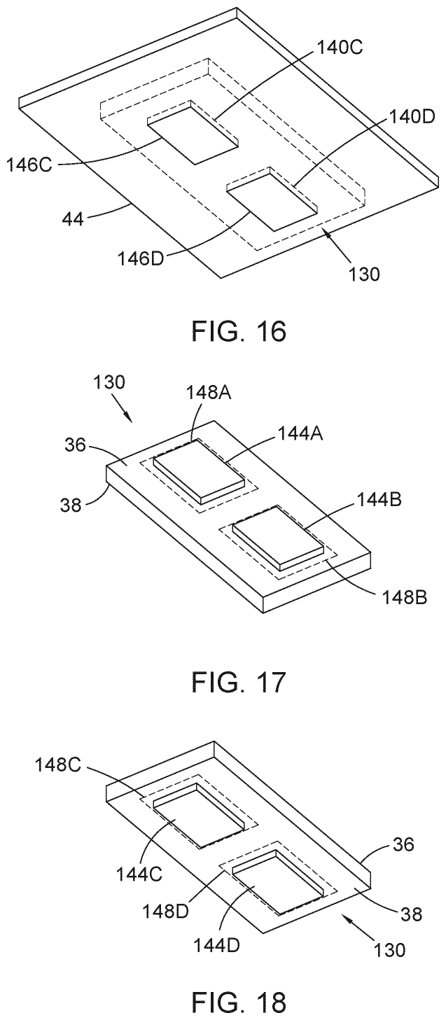

With reference to FIGS. 15 and 16, a first layer 44 of susceptor material is laid over the first surface 36 of the support 130. The susceptor layer 44 is a metal foil or film, for example an aluminium foil or film. The susceptor layer is reversibly fixed to the support 130 by an appropriate fixing material (not shown).

A kiss cutter, not shown, is caused to cut closed cut lines 146A, 146B into the first susceptor layer 44. The closed cut lines 146A, 146B coincide with the outer perimeters of enhanced areas 140A, 140B. Thereafter, or simultaneously a second layer 44 of susceptor material is laid over the second surface 38 of the support 130. Each susceptor layer 44 is a metal foil or film, for example an aluminium foil or film. The susceptor layer is reversibly fixed to the support 130 by an appropriate fixing material (not shown).

A kiss cutter, not shown, is caused to cut closed cut lines 146C, 146D into the second susceptor layer 44. The closed cut lines 146C, 146D coincide with the outer perimeters of enhanced areas 140C, 140D

With reference to FIGS. 17 and 18, once the closed cut lines 146A, 146B, 146C, 146D have been formed the portions of the first and second susceptor layers 44 that are not within a closed cut line 146A, 146B, 146C, 146D are removed from the support 130 leaving first, second, third and fourth susceptor portions 144A, 144B, 144C, 144D on the support 130 overlying enhanced areas 140A, 140B, 140C, 140D.

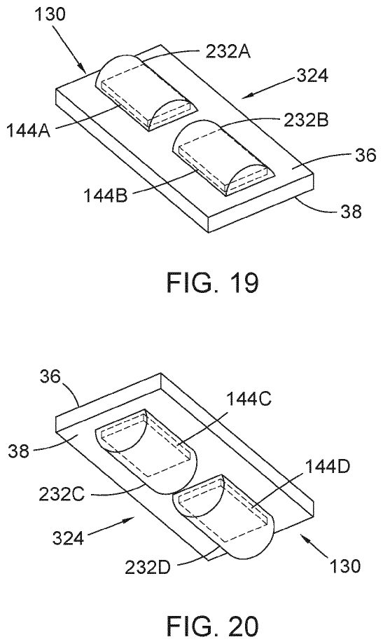

With reference to FIGS. 19 and 20, distinct portions of aerosol generating material 232A, 232B, 232D, 232D are next applied to the susceptor portions 144A, 144B, 144C, 144D and surrounding zones or areas 148A, 148B, 148C, 148D. Surrounding zones 148A, 148B are zones of the first surface 36 that extend around the perimeter of the enhanced areas 140A, 140B. Surrounding zones 148C, 148D are zones of the second surface 38 that extend around the perimeter of the enhanced areas 140C, 140D.

The aerosol generating material portions 232A, 232B, 232D, 232D thus overlie the whole of the surfaces of the susceptor portions 144A, 144B, 144C, 144D that are not facing the enhanced areas 140A, 140B, 140C, 140D. In some examples of the present disclosure, the surrounding zones 148A, 148B, 148C, 148D each extend less than 1 mm, less than 2 mm, less than 3 mm, less than 4 mm, less than 5 mm, less than 6 mm, less than 8 mm, or less than 10 mm from the perimeter of the enhanced areas 140A, 140B, 140C, 140D.

The portions of aerosol generating material 232A, 232B, 232D, 232D are applied to the susceptor portions 144A, 144B, 144C, 144D and zones 148A, 148B, 148C, 148D in the form of a slurry in a similar fashion to the application of the aerosol generating material discussed in connection with FIGS. 2 to 4. Once the slurry of aerosol generating material portions 232A, 232B, 232D, 232D has dried the consumable 324 can be used to produce aerosol using an aerosol provision device 2.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A method of manufacturing a consumable for use with a non-combustible aerosol provision system, in which the consumable comprises a support and aerosol generating material, in which the method comprises
providing a support,
causing the formation of at least one enhanced area on the support,
applying the aerosol generating material to the support in at least one position that corresponds to at least part of at least one enhanced area.

2. A method according to claim 1 in which an enhanced area is an area in which the enhancement is that the rigidity of the support is greater than the rigidity of the support in an area of the support that is not enhanced, and the formation of at least one enhanced area comprises increasing the rigidity of the support in at least part of at least one enhanced area.

3. A method according to claim 1 in which an enhanced area is an area in which the enhancement is that at least part of the surface of the area is contoured, and the formation of at least one enhanced area comprises embossing or debossing the support in at least part of at least one enhanced area.

4. A method according to claim 1 in which an enhanced area is an area in which the enhancement is that the thermal transmissivity of the support is greater than the thermal transmissivity of the support in an area of the support that is not enhanced, and the formation of at least one enhanced area comprises increasing the thermal transmissivity of at least part of at least one enhanced area.

5. A method according to claim 1 in which an enhanced area is an area in which the enhancement is that the thickness of the support is greater than the thickness of the support in an area of the support that is not enhanced, and the formation of at least one enhanced area comprises increasing the thickness of the support in at least part of the at least one enhanced area.

6. A method according to claim 1 in which an enhanced area is an area in which the enhancement is that the area comprises a susceptor, and the formation of at least one enhanced area comprises the application of a susceptor to at least part of at least one enhanced area.

7. A method according to claim 6 in which the application of a susceptor to at least part of at least one enhanced area comprises the application of one or more preshaped portions of susceptor.

8. A method according to claim 6 in which the application of a susceptor to at least part of at least one enhanced area comprises application of a sheet of susceptor to the support, kiss cutting the susceptor to form at least one predetermined closed cut line in the susceptor, and then removing the portions of susceptor that are not within a closed cut line, and the cut line coincides with or falls within the perimeter of at least one enhanced area.

9. A method according to claim 6 in which the susceptor comprises a metal or a metal alloy.

10. A method according to claim 6 in which the method of the application of the susceptor to at least part of at least one enhanced area comprises the use of hot foil stamping techniques.

11. A method according to claim 2 in which at least one enhanced area comprises two or more enhancements.

12. A method according to claim 1 in which the formation of at least one enhanced area comprises forming at least two separate enhanced areas.

13. A method according to claim 12 in which at least two separate enhanced areas of the at least two separate enhanced areas are distinguishable from each other by a human or automated observer.

14. A method according to claim 1 in which the application of aerosol generating material is application to at least part of each enhanced area of the support, and no application of aerosol generating material to portions of the support not forming an enhanced area.

15. A method according to claim 1 in which the application of aerosol generating material is application to the whole of each enhanced area of the support, and no application of aerosol generating material to portions of the support not forming an enhanced area.

16. A method according to claim 1 in which the application of aerosol generating material is application to the whole of each enhanced area of the support and at least part of the support which surrounds each enhanced area, and no application of aerosol generating material to the remaining portions of the support not forming an enhanced area.

17. A method according to claim 16 in which the at least part of the support which surrounds each enhanced area is a zone extending less than 1 mm, 2 mm, 3 mm, 4 mm, 5 mm, 6 mm, 8 mm, or 10 mm from the perimeter of the enhanced area.

18. A method according to claim 1 in which the application of aerosol generating material is application of aerosol generating material to substantially all of the support.

19. A method according to claim 1 in which the application of aerosol generating material comprises application of aerosol generating material using a transfer wheel.

20. A method according to claim 1 in which the aerosol generating material is applied to a surface of the support as an aerosol generating material slurry.

21. A method according to claim 20 in which the method further comprises allowing or causing the aerosol generating material slurry to set, in which the aerosol generating material slurry sets to an aerosol generating material.

22. A method according to claim 1 in which the aerosol generating material is applied as a set aerosol generating material.

23. A method according to claim 22 in which applying the aerosol generating material comprises hot stamping the aerosol generating material onto the support.

24. A method according to claim 21 in which the aerosol generating material is an aerosol generating film.

25. A method according to claim 1 in which causing the formation of at least one enhanced area on the support and applying the aerosol generating material occurs at substantially the same time

26. A method according to claim 1 in which the support comprises a sheet with a first and second surface,
formation of least one enhanced area comprises formation of the at least one enhanced area on one or both of the first and second surfaces of the support, and
the application of aerosol generating material is application of aerosol generating material to one or both of
(i) at least part of the at least one enhanced area, and
(ii) at least part of the portion of a surface corresponding in position to the position of the at least one enhanced area on the other surface.

27. A method according to claim 1 in which the support comprises a sheet with a first and second surface, and formation of least one enhanced area comprises formation of at least one enhanced area on the first and second surfaces of the support.

28. A consumable for use with a non-combustible aerosol provision system, in which the consumable comprises a support, at least one enhanced area on the support, and aerosol generating material, and the aerosol generating material is supported on the support in at least one position that corresponds to at least part of at least one enhanced area.

29. A consumable according to claim 28 in which the enhancement in at least one enhanced area of the support is that at least part of at least one enhanced area has an increased rigidity relative to the portions of the support that are not part of an enhanced area.

30. A consumable according to claim 28 in which the enhancement in at least one enhanced area of the support is that at least part of at least one enhanced area has an increased thermal transmissivity relative to the portions of the support that are not part of an enhanced area.

31. A consumable according to claim 28 in which the enhancement in at least one enhanced area of the support is that at least part of at least one enhanced area is embossed or debossed.

32. A consumable according to claim 28 in which the enhancement in at least one enhanced area of the support is that at least part of at least one enhanced area has an increased thickness relative to the portions of the support that are not part of an enhanced area.

33. A consumable according to claim 28 in which the enhancement in at least one enhanced area of the support is that at least one enhanced area comprises a susceptor.

34. A consumable according to claim 33 in which the susceptor is a metal or metal alloy.

35. A consumable according to claim 33 in which the susceptor has an outer perimeter which matches the shape and dimensions of the perimeter of the enhanced area to which the susceptor is applied.

36. A consumable according to claim 33 in which the susceptor covers at least part of the enhanced area and the outer perimeter of the enhanced area encompasses the susceptor.

37. A consumable according to claim 28 in which at least one enhanced area comprises two or more enhancements.

38. A consumable according to claim 28 in which there are at least two separate enhanced areas.

39. A consumable according to claim 38 in which at least two separate enhanced areas of the at least two separate enhanced areas are distinguishable from each other by a human or automated observer.

40. A consumable according to claim 28 in which aerosol generating material is supported on at least part of each enhanced area, and no aerosol generating material is supported on portions of the support not forming an enhanced area.

41. A consumable according to claim 28 in which the whole of each enhanced area supports aerosol generating material, and no aerosol generating material is supported on portions of the support not forming an enhanced area.

42. A consumable according to claim 28 in which the whole of each enhanced area and a surrounding zone supports aerosol generating material and no aerosol generating material is supported on the portions of the support not forming an enhanced area or a surrounding zone.

43. A consumable according to claim 42 in which the surrounding zone is a zone extending less than 1 mm, less than 2 mm, less than 3 mm, less than 4 mm, less than 5 mm, less than 6 mm, less than 8 mm, or less than 10 mm from the perimeter of the enhanced area.

44. A consumable according to claim 28 in which substantially all of the support supports the aerosol generating material.

45. A consumable according to claim 28 in which the aerosol generating material comprises an aerosol generating film or a gel.

46. A consumable according to claim 28 in which the support comprises a sheet with a first and second surface, at least one enhanced area is located on one or both of the first and second surfaces of the support, and aerosol generating material is supported on one or both of (i) at least part of the at least one enhanced area, and (ii) at least part of the portion of a surface corresponding in position to the position of the at least one enhanced area on the other surface.

47. A consumable according to claim 28 in which the support comprises a sheet with a first and second surface, and at least one enhanced area is located on each of the first and second surfaces of the support.

48. An aerosol provision device for use with a consumable according to claim 28, in which the device comprises an aerosol generator configured to heat at least a portion of the aerosol generating material supported on the consumable.

49. An aerosol provision system comprising an aerosol provision device according to claim 48 and a consumable in which the consumable comprises a support, at least one enhanced area on the support, and aerosol generating material, and the aerosol generating material is supported on the support in at least one position that corresponds to at least part of at least one enhanced area.

50. A method of generating aerosol from a consumable according to claim 28 using an aerosol-generating device with at least one aerosol generator disposed to heat, but not burn, the consumable in use; wherein at least one aerosol generator is a resistive heater element or a magnetic field generator and a susceptor.
